(19) United States
(12) Patent Application Publication
(10) Pub. No.: US 2004/0117793 A1
(43) Pub. Date: Jun. 17, 2004

(54) Operating system architecture employing synchronous tasks

(75) Inventor: Nicholas Shaylor, Sunnyvale, CA (US)

Correspondence Address: GUNNISON MCKAY & HODGSON, LLP, 1900 GARDEN ROAD, SUITE 220, MONTEREY, CA, 93940, US

(73) Assignee: Sun Microsystems, Inc.

(21) Appl. No.: 10/322,382

(22) Filed: Dec. 17, 2002

(51) Int. Cl. G06F 9/46

(52) U.S. Cl. 718/100

(57) ABSTRACT

A method of executing a thread is disclosed. The method includes indicating that the thread is one of a pre-emptible thread and a non-pre-emptible thread.

### CROSS REFERENCE TO ATTACHED APPENDIX

Appendix A contains the following files in one CD-ROM (of which two identical copies are attached hereto), and is part of the present disclosure and is incorporated by reference in its entirety:

| | | | |
|---|---|---|---|
| 10/30/2002 | 1:16a | 8,638 | operaini.c.txt |
| 10/30/2002 | 11:14a | 6,730 | majcregs.h.txt |
| 12/16/2002 | 04:01p | 17,549 | opera.c.txt |
| 10/30/2002 | 11:14a | 23,789 | opera.h.txt |
| 12/16/2002 | 04:02p | 12,103 | operacli.c.txt |
| 10/30/2002 | 11:15a | 1,839 | operacpy.c.txt |
| 10/30/2002 | 11:15a | 7,228 | operaelf.c.txt |
| 10/30/2002 | 11:15a | 11,031 | operaelf.h.txt |
| 10/30/2002 | 11:16a | 1,957 | operagbl.c.txt |
| 10/30/2002 | 11:13a | 29,663 | majc.S.txt |
| 10/30/2002 | 11:16a | 100,072 | operaknl.c.txt |
| 10/30/2002 | 11:16a | 23,812 | operaldr.c.txt |
| 10/30/2002 | 11:17a | 7,109 | operalib.c.txt |
| 10/30/2002 | 11:17a | 10,905 | operamem.c.txt |
| 10/30/2002 | 11:17a | 7,552 | operatsk.c.txt |
| 12/16/2002 | 04:09p | 21,108 | operatst.c.txt |
| 12/16/2002 | 04:15p | 1,061 | filelist.txt |

The files of Appendix A form source code of computer programs and related data of an illustrative embodiment of the present invention. More specifically, the files provide source code in the C and assembly programming languages for an implementation of an operating system providing the functionalities discussed herein.

### BACKGROUND OF THE INVENTION

1. Field of the Invention

The present invention relates to operating systems, and, more particularly, to an operating system architecture supporting optional thread pre-emption with user-mode tasks.

2. Description of the Related Art

An operating system is an organized collection of programs and data that is specifically designed to manage the resources of computer system and to facilitate the creation of computer programs and control their execution on that system. The use of an operating system obviates the need to provide individual and unique access to the hardware of a computer for each user wishing to run a program on that computer. This simplifies the user's task of writing of a program because the user is relieved of having to write routines to interface the program to the computer's hardware. Instead, the user accesses such functionality using standard system calls, which are generally referred to in the aggregate as an application programming interface (API).

A current trend in the design of operating systems is toward smaller operating systems. In particular, operating systems known as micro kernels are becoming increasingly prevalent. In certain microkernel operating system architectures, some of the functions normally associated with the operating system, accessed via calls to the operating system's API, are moved into the user space and executed as user tasks. Microkernel thus tend to be faster and simpler than more complex operating systems.

These advantages are of particular benefit in specialized applications that do not require the range of functionalities provided by a standard operating system. For example, a microkernel-based system is particularly well suited to embedded applications. Embedded applications include information appliances (personal digital assistance (PDAs), network computers, cellular phones, and other such devices), household appliances (e.g., televisions, electronic games, kitchen appliances, and the like), and other such applications. The modularity provided by a microkernel allows only the necessary functions (modules) to be used. Thus, the code required to operate such a device can be kept to a minimum by starting with the microkernel and adding only those modules required for the device's operation. The simplicity afforded by the use of a microkernel also makes programming such devices simpler.

In real-time applications, particularly in embedded real-time applications, the speed provided by a microkernel-based operating system architecture can be of great benefit. System calls are simplified by making the time taken executing the corresponding kernel code more predictable. This, in turn, simplifies the programming of real-time applications. This is of particular importance when writing software for control operations, such as is often the case in embedded systems.

Threaded processes are often used in such systems to provide more efficient use of the available processing power by allowing a portion of a process (a thread) to execute while another portion(s) of the process (thread(s)) are waiting. Thus, an entire process need not cease being processed simply because a certain portion of that process is awaiting an event (e.g., I/O, the availability of a system resource, or the like). Another example is the use of threaded processes in a computer system employing a symmetric multi-processor (SMP) architecture. In such a situation, one or more of a multi-threaded process's threads can be migrated to various of the processors available, thus allowing load balancing. If such migration is dynamic, the load balancing can be performed dynamically. It will be noted that support for multi-threading can be provided in the given operating system or in a user library.

However, the use of threaded applications, especially in real-time, but, in fact, other applications can present difficulties. For example, threads within a single task can pre-empt one another (i.e., running asynchronously, can wrest control from one another). The problem this causes is that multiple threads preempting one another can give rise to timing-induced errors (i.e., asynchronous “bugs”). Detection and correction of errors from by non-timing-related sources is, typically, a relatively straightforward task, in part because such errors are usually easy to replicate: programming code that contains a non-timing-related error will always experience that error when run with the same inputs (i.e., if the path through the code that contains the error is taken, the error will occur, assuming the state of the program is the same).

In contrast, timing-induced errors occur, in part, as a result of the state of asynchronous (time and sequence independent) inputs (e.g., an interrupt or the sequence in which threads are executed). Such errors can be tremendously difficult to isolate and identify, because controlling parameters such as asynchronous inputs and the sequence of thread execution is so difficult (if not impossible). Thus, while allowing the threads of a multi-threaded process to execute independently (and thus, to pre-empt one another) is desirable, it is also desirable to simplify the identification and correction of timing-induced errors.

### SUMMARY OF THE INVENTION

In one embodiment of the present invention, a method of executing a thread is disclosed. The method includes indicating that the thread is one of a pre-emptible thread and a non-pre-emptible thread.

In another embodiment of the present invention, a method of executing a thread is disclosed. The method includes preventing a first thread from pre-empting the thread. The first thread and the thread are ones of a number of threads. A task includes the threads. The first thread is prevented from pre-empting the thread until the thread makes a system call to an operating system.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 illustrates the organization of an exemplary system architecture.

FIG. 2 illustrates the organization of an exemplary system architecture showing various user tasks.

FIG. 3 illustrates the organization of an exemplary message data structure.

FIG. 4 illustrates an exemplary data structure of a data description record that provides data in-line.

The use of the same reference symbols in different drawings indicates similar or identical items.

### DETAILED DESCRIPTION OF THE INVENTION

The following is intended to provide a detailed description of an example of the invention and should not be taken to be limiting of the invention itself. Rather, any number of variations may fall within the scope of the invention which is defined in the claims following the description.

### Introduction

It is the inventors' belief that, preferably, a kernel should provide support for selectability of thread pre-emption (i.e., allowing the user to select whether or not threads are pre-emptible in a given process). Such support allows tasks using non-pre-emptible threads to avoid the use of atomic instructions (e.g., mutex locks), but increases the latency a thread may experience in waiting to run.

In a system architecture that supports thread pre-emption (again, preferably optional), context switches are allowed within a task (from one thread in a given task to another thread in that task) only if the task is configured to allow such context switches (i.e., pre-emption (asynchronous operation)). It will be noted that, if the task is configured to be synchronous, only one thread can execute at a time, because each thread is non-pre-emptible (and so each must wait its turn). This provides the advantages of threads, without the need for a synchronization mechanism, thereby simplifying the system architecture. While one or more (or all) tasks within a system architecture can be made synchronous, allowing non-pre-emptibility to be optional within such tasks (i.e., to allow such tasks to be configured as synchronous and asynchronous) will likely be preferable.

### Example Operating System Supporting Optional Thread Pre-Emption

Example System Architecture

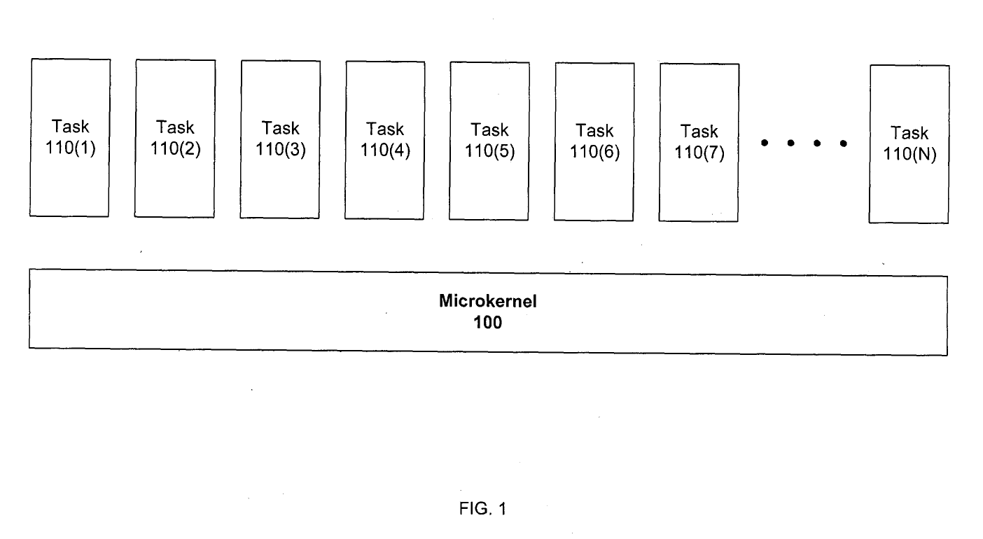

FIG. 1 illustrates an exemplary system architecture of an operating system capable of supporting (and employing) a thread pre-emption system according to embodiments of the present invention. Such a system architecture is depicted in FIG. 1 as a microkernel 100. Microkernel 100 provides a minimal set of directives (operating system functions, also known as operating system calls). Most (if not all) functions normally associated with an operating system thus exist in the operating system architecture's user-space. The ability to control thread pre-emption is therefore of particular importance in such a scenario, as a result of so much of such an operating system's functionality exists in the user-space. Multiple tasks (exemplified in FIG. 1 by tasks 110(1)-(N)) are then run on microkernel 100, some of which provide the functionalities no longer supported within the operating system (microkernel 100). Each of these tasks (kernel-space and/or user-space) is made up of one or more threads of execution (or, more simply, threads).

A thread may be conceptualized as an execution path through a program. Often, several largely independent tasks must be performed that do not need to be serialized (i.e., they do not need to be executed seriatim, and so can be executed concurrently). For instance, a database server may process numerous unrelated client requests. Because these requests need not be serviced in a particular order, they may be treated as independent execution units, which in principle could be executed in parallel. Such an application would perform better if the processing system provided mechanisms for concurrent execution of the sub-tasks.

Traditional systems often implement such programs using multiple processes. For example, most server applications have a listener thread that waits for client requests. When a request arrives, the listener forks a new process to service the request. Since servicing of the request often involves I/O operations that may block the process, this approach can yield some concurrency benefits even on uniprocessor systems.

Using multiple processes in an application can present certain disadvantages. Creating all these processes adds substantial overhead, since forking a new process is usually an expensive system call. Additional work is required to dispatch processes to different machines or processors, pass information between these processes, wait for their completion, and gather the results. Finally, such systems often have no appropriate frameworks for sharing certain resources, e.g., network connections. Such a model is justified only if the benefits of concurrency offset the cost of creating and managing multiple processes.

These examples serve primarily to underscore the inadequacies of the process abstraction and the need for better facilities for concurrent computation. The concept of a fairly independent computational unit that is part of the total processing work of an application is thus of some importance. These units have relatively few interactions with one another and hence low synchronization requirements. An application may contain one or more such units. The thread abstraction represents such a single computational unit.

Thus, by using the thread abstraction, a process becomes a compound entity that can be divided into two components—a set of threads and a collection of resources. The thread is a dynamic object that represents a control point in the process and that executes a sequence of instructions. The resources, which include an address space, open files, user credentials, quotas, and so on, may be shared by all threads in the process, or may be defined on a thread-by-thread basis, or a combination thereof. In addition, each thread may have its private objects, such as a program counter, a stack, and a register context. The traditional process has a single thread of execution. Multi-threaded systems extend this concept by allowing more than one thread of execution in each process. Several different types of threads, each having different properties and uses, may be defined. Types of threads include kernel threads and user threads.

A kernel thread need not be associated with a user process, and is created and destroyed as needed by the kernel. A kernel thread is normally responsible for executing a specific function. Each kernel thread shares the kernel code (also referred to as kernel text) and global data, and has its own kernel stack. Kernel threads can be independently scheduled and can use standard synchronization mechanisms of the kernel. As an example, kernel threads are useful for performing operations such as asynchronous I/O. In such a scenario, the kernel can simply create a new thread to handle each such request instead of providing special asynchronous I/O mechanisms. The request is handled synchronously by the thread, but appears asynchronous to the rest of the kernel. Kernel threads may also be used to handle interrupts.

It is also possible to provide the thread abstraction at the user level. This may be accomplished, for example, through the implementation of user libraries or via support by the operating system. Such user libraries normally provide various directives for creating, synchronizing, scheduling, and managing threads without special assistance from the kernel. The implementation of user threads using a user library is possible because the user-level context of a thread can be saved and restored without kernel intervention. Each user thread may have, for example, its own user stack, an area to save user-level register context, and other state information. The library schedules and switches context between user threads by saving the current thread's stack and registers, then loading those of the newly scheduled one. The kernel retains the responsibility for process switching, because it alone has the privilege to modify the memory management registers.

Threads provide several benefits. For example, the use of threads provides a more natural way of programming many applications (e.g., windowing systems). Threads can also provide a synchronous programming paradigm by hiding the complexities of asynchronous operations in the threads' library or operating system. The greatest advantage of threads is the improvement in performance such a paradigm provides. Threads can be extremely lightweight and consume little or no kernel resources, requiring much less time for creation, destruction, and synchronization in an operating system according to the present invention.

It will be noted that the variable identifier “N”, as well as other such identifiers, are used in several instances in FIG. 1 and elsewhere to more simply designate the final element (e.g., task 110(N) and so on) of a series of related or similar elements (e.g., tasks 110(1)-(N) and so on). The repeated use of such a variable identifier is not meant to imply a correlation between the sizes of such series of elements. The use of such a variable identifier does not require that each series of elements has the same number of elements as another series delimited by the same variable identifier. Rather, in each instance of use, the variable identified by “N” (or other variable identifier) may hold the same or a different value than other instances of the same variable identifier.

It will also be noted that, while it is appreciated that operations discussed herein may consist of directly entered commands by a computer system user or by steps executed by application specific hardware modules, the present invention includes steps that can be executed by software modules. The functionality of steps referred to herein may correspond to the functionality of modules or portions of modules.

The operations referred to herein may be modules or portions of modules (e.g., software, firmware or hardware modules). For example, although the described embodiment includes software modules and/or includes manually entered user commands, the various exemplary modules may be application specific hardware modules. The software modules discussed herein may include script, batch or other executable files, or combinations and/or portions of such files. The software modules may include a computer program or subroutines thereof encoded on computer-readable media.

Additionally, those skilled in the art will recognize that the boundaries between modules are merely illustrative and alternative embodiments may merge modules or impose an alternative decomposition of functionality of modules. For example, the modules discussed herein may be decomposed into submodules to be executed as multiple computer processes. Moreover, alternative embodiments may combine multiple instances of a particular module or submodule. Furthermore, those skilled in the art will recognize that the operations described in exemplary embodiment are for illustration only. Operations may be combined or the functionality of the operations may be distributed in additional operations in accordance with the invention.

Each of the actions described herein may be executed by a module (e.g., a software module) or a portion of a module or a computer system user. Thus, the above described method, the operations thereof and modules therefor may be executed on a computer system configured to execute the operations of the method and/or may be executed from computer-readable media. The method may be embodied in a machine-readable and/or computer-readable medium for configuring a computer system to execute the method. Thus, the software modules may be stored within and/or transmitted to a computer system memory to configure the computer system to perform the functions of the module. The preceding discussion is equally applicable to the other flow diagrams described herein.

The software modules described herein may be received by a computer system, for example, from computer readable media. The computer readable media may be permanently, removably or remotely coupled to the computer system. The computer readable media may non-exclusively include, for example, any number of the following: magnetic storage media including disk and tape storage media; optical storage media such as compact disk media (e.g., CD-ROM, CD-R, and the like) and digital video disk storage media; nonvolatile memory storage memory including semiconductor-based memory units such as FLASH memory, EEPROM, EPROM, ROM or application specific integrated circuits; volatile storage media including registers, buffers or caches, main memory, RAM, and the like; and data transmission media including computer network, point-to-point telecommunication, and carrier wave transmission media. In a UNIX-based embodiment, the software modules may be embodied in a file which may be a device, a terminal, a local or remote file, a socket, a network connection, a signal, or other expedient of communication or state change. Other new and various types of computer-readable media may be used to store and/or transmit the software modules discussed herein.

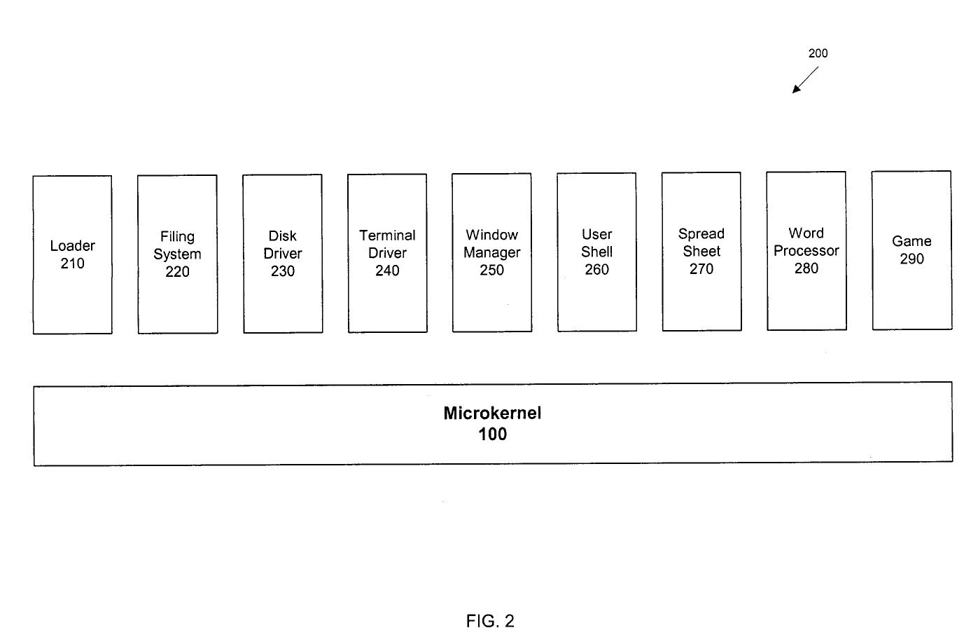

FIG. 2 depicts examples of some of the operating system functions moved into the user-space, along with examples of user processes that are normally run in such environments. Erstwhile operating system functions moved into the user-space include a loader 210 (which loads and begins execution of user applications), a filing system 220 (which allows for the orderly storage and retrieval of files), a disk driver 230 (which allows communication with, e.g., a hard disk storage device), and a terminal driver 240 (which allows communication with one or more user terminals connected to the computer running the processes shown in FIG. 2, including microkernel 100). Other processes, while not traditionally characterized as operating system functions, but that normally run in the user-space, are exemplified here by a window manager 250 (which controls the operation and display of a graphical user interface [GUI]) and a user shell 260 (which allows, for example, a command-line or graphical user interface to the operating system (e.g., microkernel 100) and other processes-running on the computer). User processes (applications) depicted in FIG. 2 include a spreadsheet 270, a word processor 280, and a game 290. As will be apparent to one of skill in the art, a vast number of possible user processes that could be run on microkernel 100 exist. This points out the utility of providing non-pre-emptible threads, and, more generally, of control over thread pre-emptibility.

In an operating system architecture such as that shown in FIG. 2, drivers and other system components are not part of the microkernel. As a result, input/output (I/O) requests are passed to the drivers using a message passing system. The sender of the request calls the microkernel and the microkernel copies the request into the driver (or other task) and then switches user mode execution to that task to process the request. When processing of the request is complete, the microkernel copies any results back to the sender task and the user mode context is switched back to the sender task. The use of such a message passing system therefore enables drivers (e.g., disk driver 230) to be moved from the microkernel to a task in user-space.

Example Directives

Directives defined in microkernel 100 may include, for example, a create thread directive (Create), a destroy thread directive (Destroy), a send message directive (Send), a receive message directive (Receive), a fetch data directive (Fetch), a store data directive (Store), and a reply directive (Reply). These directives allow for the manipulation of threads, the passing of messages, and the transfer of data.

The Create directive causes microkernel 100 to create a new thread of execution in the process of the calling thread. In one embodiment, the Create command clones all the qualities of the calling thread into the thread being created. Its counterpart, the Destroy directive, causes microkernel 100 to destroy the calling thread. It will be noted that output parameters for the Destroy directive are only returned if the Destroy directive fails (otherwise, if the Destroy directive is successful, the calling thread is destroyed and there is no thread to which results (or control) may be returned from the Destroy call).

The Send directive causes microkernel 100 to suspend the execution of the calling thread, initiate an input/output (I/O) operation and restart the calling thread once the I/O operation has completed. In this manner, a message is sent by the calling thread. The calling thread sends the message (or causes a message to be sent (e.g., DMA, interrupt, or similar situations) to the intended thread, which then replies as to the outcome of the communication using a Reply directive.

The Receive directive causes microkernel 100 to suspend the execution of the calling thread until an incoming I/O operation is presented to one of the calling thread's process's I/O channels (the abstraction that allows a task to receive messages from other tasks and other sources). By waiting for a thread control block to be queued to on of the calling thread's process's I/O channels, a message is received by the calling thread.

The Fetch directive causes microkernel 100 (or a stand-alone copy process, discussed subsequently) to copy any data sent to the receiver into a buffer in the caller's address space. Its counterpart, the Store directive, causes microkernel 100 (or a stand-alone copy process, discussed subsequently) to copy data to the I/O sender's address space. The Reply directive causes microkernel 100 to pass reply status to the sender of a message. The calling thread is not blocked, and the sending thread is released for execution.

The preceding directives allow tasks to effectively and efficiently transfer data, and manage threads and messages. A more detailed discussion of such directives is provided in patent application No. 09/498,606, entitled “A SIMPLIFIED MICROKERNEL APPLICATION PROGRAMMING INTERFACE,” and having N. Shaylor as inventor, which is assigned to Sun Microsystems, Inc., the assignee of the present invention, and is incorporated herein by reference, in its entirety and for all purposes. The use of messages for inter-task communications and in supporting common operating system functionality is now briefly described.

Message Passing Architecture

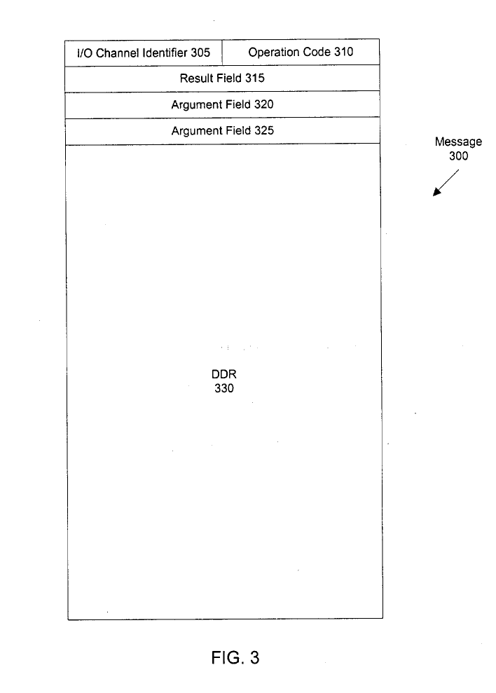

FIG. 3 illustrates an exemplary structure of a message 300. As noted above, a message such as message 300 can be sent from one task to another using the Send directive, and received by a task using the Receive directive. The architecture used in microkernel 100 is based on a message passing architecture in which tasks communicate with one another via messages sent through microkernel 100. Message 300 is an example of a structure which may be used for inter-task communications in microkernel 100. Message 300 includes an I/O channel identifier 305, an operation code 310, a result field 315, argument fields 320 and 325, and a data description record (DDR) 330. I/0 channel identifier 305 is used to indicate the I/O channel of the task receiving the message. Operation code 310 indicates the operation that is being requested by the sender of the message. Result field 315 is available to allow the task receiving the message to communicate the result of the actions requested by the message to the message's sender. In a similar manner, argument fields 320 and 325 allow a sender to provide parameters to a receiver to enable the receiver to carry out the requested actions. DDR 330 is the vehicle by which data (if needed) is transferred from the sending task to the receiving task. As will be apparent to one of skill in the art, while argument fields 320 and 325 are discussed in terms of parameters, argument fields 320 and 325 can also be viewed as simply carrying small amounts of specific data.

A more detailed discussion of message passing is provided in patent application No. 09/650,370 (Attorney Docket Number SP-3697 US), entitled “A GENERAL DATA STRUCTURE FOR DESCRIBING LOGICAL DATA SPACES,” and having N. Shaylor as inventor, which is assigned to Sun Microsystems, Inc., the assignee of the present invention, and is incorporated herein by reference, in its entirety and for all purposes. Further details of message passing can also be found in the Patent Application entitled “A SIMPLIFIED MICROKERNEL APPLICATION PROGRAMMING INTERFACE,” as previously included by reference herein.

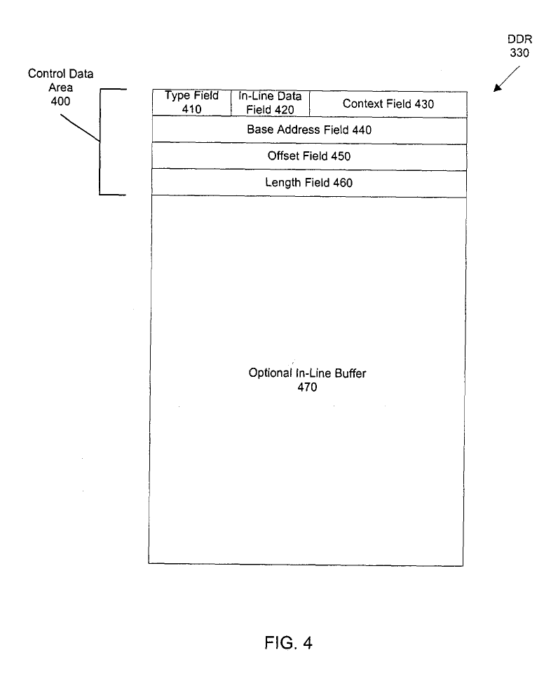

FIG. 4 illustrates an exemplary structure of DDR 330. Included in DDR 330 is a control data area 400, which includes a type field 410, an in-line data field 420, a context field 430, a base address field 440, an offset field 450, a length field 460, and an optional in-line buffer 470. Type field 410 indicates the data structured used by DDR 330 to transfer data to the receiving task. In-line data field 420 is used to indicate when the data being transferred is stored within DDR 330 (i.e., when the data is “in-line data” in optional in-line buffer 470). Alternatively, in-line data field 420 may be used to indicate not only whether in-line data exists, but also the amount thereof. Storing small amounts of data (e.g., 32, 64 or 96 bytes) in optional in-line buffer 470 is an efficient way to transfer such small amounts of data. In fact, microkernel 100 can be optimized for the transfer of such small amounts of data using such structures. In contrast, a larger amount of data would prove cumbersome (or even impossible) to transfer using optional in-line buffer 470, and so is preferably transferred using, for example, one of the data structures described in the Patent Application entitled “A GENERAL DATA STRUCTURE FOR DESCRIBING LOGICAL DATA SPACES,” as previously included by reference herein, which also provides a more detailed discussion of DDR 330.

### Optional Thread Pre-Emption Within a User Task

As noted, from an internal perspective, a task is made up of one or more threads of execution (threads). If multi-threaded tasks and synchronous threads (even optional thread pre-emption) are supported in a given system architecture, threads within a given task can be synchronous (threads in the task are not pre-emptible, and so may not pre-empt one another (i.e., another thread cannot cause a context switch)). If thread pre-emption is optional, threads within a given task can also be asynchronous (threads in the task are pre-emptible, and so may pre-empt one another (i.e., another thread can cause a context switch)). The task is said to be synchronous or asynchronous, respectively.

The primary result of pre-emption is that a context switch is effected, and so context switches from that of the thread being preempted, to that of the thread causing the pre-emption. Thus, in a task that is asynchronous, threads may pre-empt one another, and so one thread can force a context switch from another thread, without the other thread voluntarily relinquishing control. Correspondingly, in a task that is synchronous, threads may not pre-empt one another, and so one thread cannot cause a context switch from another thread without the other thread voluntarily relinquishing control. This occurs when the task being pre-empted is at a well-defined point in its execution and makes a system call (e.g., a point at which execution of the thread transfers control to the kernel). By contrast, in a task in which threads are pre-emptible, a thread need not reach a well-defined point or make a system call before another thread in that task is allowed to pre-empt the first thread. In sum, then, it can be said that a non-pre-emptible thread can relinquish control (execution), but cannot have control taken away.

Thus, in a system architecture that supports thread pre-emption (either “hard-coded” or optional in some fashion), context switches are allowed within a task (from one thread in a given task to another thread in that task) only if the task is configured to allow such context switches (i.e., pre-emption (asynchronous operation)). It will be noted that, if the task is configured to be synchronous, only one thread can execute at a time, because each thread is non-pre-emptible (and so each must wait its turn). This provides the advantages of threads, without the need for a synchronization mechanism, thereby simplifying the system architecture. While one or more (or all) tasks within a system architecture can be made synchronous, allowing non-pre-emptibility to be optional within such tasks (i.e., to allow such tasks to be configured as synchronous and asynchronous) will likely be preferable.

It is the inventors' belief that, preferably, a kernel should provide support for selectability (i.e., allowing the user to select whether or not threads are pre-emptible in a given process). Such support allows tasks using non-pre-emptible threads to avoid the use of atomic instructions (e.g., mutex locks), but increases the latency a thread may experience in waiting to run.

It will be noted that, although threads within a given task can be made non-pre-emptible (i.e., synchronous), the tasks, as to one another, are (or at least, can be) pre-emptible, and remain so. Thus, while one task is still able to pre-empt another task, the synchronization performed is synchronization between threads within a given task, and when such pre-emption is disabled, no thread can pre-empt another thread in that task. One task is therefore still able to pre-empt another task, even though the other task is executing one of its non-pre-emptible threads (and so pre-emption of threads is only meaningful within a given task).

As noted, a problem experienced with pre-emptible threads is that multiple threads preempting one another can give rise to timing-induced errors (i.e., asynchronous “bugs”), or at least make timing-related errors more difficult to reproduce, identify and correct. As also noted, timing-induced errors can occur, in part, as a result of the state of asynchronous (time and sequence independent) inputs (e.g., an interrupt or the sequence in which threads are executed). By making threads non-pre-emptible (i.e., synchronous), these and other types of timing-related errors can be precluded.

The ability to provide synchronous tasks (i.e., non-pre-emptible threads) is important for a variety of reasons. If a task is made synchronous (i.e., thread pre-emption is not allowed), there will be fewer errors, in general, because an entire class of errors (timing-related errors) is eliminated. The avoidance of timing-related errors is important in several respects, as discussed above and further discussed now. The ability to make a task's threads synchronous, in addition to avoiding timing-related errors, allows a synchronous thread's code to be simpler. For example, code to insert an entry into a queue can be simplified if the programmer knows that there is no way for the-code performing such a task to be pre-empted by another thread in the same process before the process of inserting the entry has completed. A segment of pseudo-code for performing an insertion into a queue (in this example, a doubly-linked list) is now presented:

before_tmp_ptr=entry before insertion point;

after_tmp_ptr=entry after insertion point;

before_tmp_ptr.forward_prt=new_entry;

after_tmp_ptr.back_prt=new_entry;

new_entry.back_ptr=before_tmp ptr;

new_entry.forward_ptr=after _tmp_ptr;

However, it will be apparent to one of skill in the art that, if the above-listed instructions are interrupted (i.e., due to a pre-emption), the queue can be corrupted, and any accesses by other threads may (an likely will) produce erroneous results. Thus, if the task is asynchronous, such stretches of code (commonly referred to as “critical sections” of code) must be protected in some manner. This protection can be effected, for example, by the use of a lock semaphore, which disables context switching within the task and/or the like, making the protected section of code atomic in this respect.

It will be noted that, in discussing this scenario in terms of interruption, it is the situation in which the thread performing the insertion is preempted (and so, may not have the opportunity to complete the insertion process before another thread in the process attempts to access the queue), and not the task to which the thread belongs (i.e., by another task). As noted, if the task performing the insertion fails to fully complete the insertion, the queue may be corrupted, and any subsequent access to that queue cause the task to crash, and thus the programmer must provide protection of such critical sections.

In the case of a synchronous thread, however, such protective instructions are not necessary, because the thread performing the insertion cannot be preempted. Thus, coding such operations is simplified, both because protective instructions are not necessary, and because the programmer need not search for and identify critical sections within their code (often a challenging task, as will be apparent to one of skill in the art).

Even when protective instructions (i.e., that make sections of code atomic) are required, such instructions tend to be simpler and less time consuming as a result of their being implemented in the user space (and so, the kernel is not involved in their execution). For example, in protecting a Send instruction, interrupts are typically disabled (e.g., via the use of disable( ) and enable( ) calls). The disable( ) and enable( ) calls are simpler and less time consuming, in comparison to making such calls to the operating system, as a result of their being implemented in the user space

In fact, entire tasks can be simplified by the use of synchronous threads. For example, one user task (i.e., one that is implemented as a process in the user-space in the example operating system described herein) is the process that manages the filesystem. Such a process is blocked waiting most of the time, awaiting various events (e.g., commands from the user or user processes, data from I/O subsystems, and the like), which are typically asynchronous. With pre-emption disabled, the asynchronicity of such events poses no problems, as such events are handled at well-defined points in the execution of the filesystem process.

However, some sort of local locking mechanism may still be required (local meaning local to the given task and its threads). For example, a filesystem typically awaits the receipt of a command, and then acts on that command. Certain commands may not successfully complete, and so their successful completion cannot be assumed. One such command is a delete directory command. As with a number of other commands, it cannot be assumed that a delete directory command will complete successfully (e.g., in the case where one or more files cannot, for whatever reason, be deleted (and so prevent the deletion of the directory in which they reside)). In order to protect the directory until it is successfully deleted, commands such as a “lock directory” command (executed prior to beginning deletion of the directory and its files) and an “unlock directory” command (executed after such deletion) can be employed. Such commands prevent the directory from being accessed or deleted until the deletion operation has concluded (either successfully or unsuccessfully). In contrast to the typical instructions employed in making a section of code atomic, the local locks used in this example are extremely lightweight (e.g., such locks can be as simple as a flag that is checked by other threads in the task, prior to accessing the directory being deleted).

Another example is a device driver (e.g., a hard-disk driver), which can be designed to support a device (e.g., a hard-disk drive) in the example operating system described herein, microkernel 100. In the case of a hard-disk drive, and so its device driver, commands are performed serially, and data is sent and retrieved serially. Configuring the device driver task for a hard-disk as a synchronous task is appropriate because only one action can be taken at a time in any event. That the threads in such a process are non-pre-emptible simply allows the task to mirror its application. It is, of course, of benefit that each thread reaches a well-defined point before handing control over to the preempting thread. The operating system, at this point, simply proceeds to the next event to be processed, and then proceeds on with the next thread to be executed. This is desirable from the perspective of the device driver because this means that the driver need only perform one action at a time. In fact, this mirrors the capabilities of most peripherals, because the hardware can only perform one task/process one event at a time.

Again, as noted, a problem experienced with pre-emptible threads is that multiple threads pre-empting one another can give rise to timing-induced errors. Such errors can be tremendously difficult to isolate and identify, because controlling parameters such as asynchronous inputs and the sequence of thread, execution is so difficult (if not impossible). The detection and correction of such errors is therefore a desirable capability. Moreover, in the situation where it is desirable to allow the threads of a multi-threaded process to execute independently (and thus, to pre-empt one another), simplifying the identification and correction of timing-induced errors is also desirable.

Optional thread pre-emption thus provides for the simplified detection and correction of errors in the design and coding of programs (commonly referred to as debugging). As noted, the existence of critical sections in asynchronous code greatly complicates both coding and debugging. However, in a system supporting optional thread pre-emption, a task's threads can be made non-pre-emptible to simplify programming, and can then be switched between pre-emptible and non-pre-emptible modes to catch errors caused by timing (i.e., timing-related bugs related, for example, to thread pre-emptions). Thus, the use of synchronous threads can be made as a step in the programming process. In such a scenario, a program is first coded and debugged while running synchronously. Once the program is running correctly with synchronous threads, the threads can be set to operate asynchronously, and the existence of any such errors (timing-related errors) will become apparent. The task can be switched between pre-emption and non-pre-emption to assist in the location and identification of such errors.

The ability to provide such selectability is simplified as a result of the functionality (i.e., support for threads, and especially optional thread pre-emption) being provided on the user side. Such optional thread pre-emption can be supported, for example, in the following manner. Each task maintains a value that indicates the number of threads that the task can simultaneously have executing (typically, either 1 or infinity, but other values can be selected), also referred to as the number of allowable concurrent threads of execution.

Thus, a task can create threads at any desired rate, as well as create any number of threads. This is, however, with the caveat that if the task has reached the limit as to the number of concurrent threads the task is running, the task must then wait. An event can change the state of the thread to “runnable” only if the limit on the number of concurrently running threads has not yet been reached. If the limit has been reached, the thread to be run goes onto a queue of otherwise runnable threads, which maintains threads which are runnable but for the fact that the task has reached its maximum number of concurrent threads. Each task thus includes a number that indicates the number of threads the task can simultaneously have executing (which indicates typically that either only a single thread may be executing, or one that indicates that any number of threads may be executing (i.e., no limitation).

This functionality is supported by the following structures within the kernel. In one embodiment, three queues are provided—one queue for threads awaiting an event, one queue for runnable threads and one queue for threads that are actually executing. For a thread to be transferred from the “runnable threads” queue and onto the “running threads” queue, the limit for the task must not yet have been reached. If this limit has been reached, then the thread waits on the runnable thread queue until there is room for that thread on the running threads queue (thus allowing for the thread's execution). An example of an operating system providing such functionality is provided in the CD-ROM appendix accompanying this application, as previously included by reference herein.

As will be apparent to one of skill in the art, it is often preferable to support selectability with regard to pre-emption. In a system according to embodiments of the present invention, if no such selectability is provided, then a task's threads would have to be set as either pre-emptible (allowing the execution of multiple threads to be spread across a number of processors) or non-pre-emptibility (avoiding the need for atomic instructions and simplifying programming of such tasks). Moreover, by forcing threads to run synchronously, programming is simplified because such timing-related issues need not be a consideration for those coding such applications. Unfortunately, the former approach often increases programmatic complexity within the given process (because such programmatic complexity cannot be hidden from the user (e.g., the need for instructions that enable atomic sections of code)) and potentially exposes such processes to timing-related errors, while the latter approach forces each task to run on a single processor, and so prevents low-level (thread-level) multitasking. The ability to select between pre-emption and non-pre-emption thus provides the programmer with a flexible approach, allowing the programmer to tailor this aspect to the task at hand, in addition to simplifying coding of the given program.

Advantageously, pre-emptibility can be configured dynamically (as discussed herein). Using dynamic configuration, a task running asynchronously on one processor can be made synchronous in preparation for the task's migration to another processor (making the task easy to migrate), and then be switched back to asynchronous operation upon its successful migration to the other processor. This is of particular benefit in a symmetric multiprocessing (SMP) environment.

The ability to provide non-pre-emptible threads is especially useful in an SMP environment. Optional thread pre-emptibilty can be presented to the user (programmer) simply as a logical construct, which is of particular benefit in an SMP environment because of its simplicity. When using non-pre-emptible threads, only one thread of each task is executed at any one time, rather than multiple threads, being executed at any one time. When pre-emption between threads is permitted, a task may have a number of threads, each being executed on one of the SMP processors, and so a task can be “spread” over several such processors. With pre-emption disabled, each task can essentially be viewed as a single thread (at least within the context of an SMP environment, because only one of the task's threads is executing at any one time). Such tasks are executed as a single thread, and so are executed on a single one of the SMP processors. The fact that only one task is executed on any one of the SMP processors, and each task is executed by only one of the processors, provides a number of benefits.

The benefits of optional thread pre-emption in an SMP environment include the simplified detection and correction of errors in the design and coding of programs (commonly referred to as debugging). Typically, during debugging of a program, there is a need to send a stop message to all tasks/threads to cause those tasks/threads to cease execution and transfer control to a debugger, a program commonly used to identify and correct errors in a program (commonly referred to as a breakpoint in the program). Normally, with pre-emptible tasks, this signal is acted upon immediately by the tasks/threads receiving the stop signal, regardless of where they may be in their execution. Because this point may change for each thread of each task, depending on the timing of each thread's execution, the time required for the stop signal to propagate to each processor, and other such phenomena, the exact state of each thread is difficult to accurately determine. Moreover, the process of stopping is much more involved for tasks running multiple threads, as a result of there being the potential for a task to have multiple threads running at any given time.

Using non-pre-emptible threads, however, a breakpoint can be inserted into the code of one thread, and when the breakpoint is encountered, the processor executing that thread stops execution. Because the task running on that processor is non-pre-emptible internally, there's only one thread to stop because there is only one thread executing at any one time for the given task. Thus, there is no issue with stopping threads running on other processors, because there is only one thread executing at any given time. Moreover, each thread can be stopped at a well-defined point, if desired.

Another advantage is that, in SMP systems in which threads and tasks are not bound to a given CPU, synchronous tasks can easily be migrated from one CPU to another because there is only one context to maintain when migrating synchronous tasks. In fact, using dynamic configuration, a task running asynchronously on one processor can be made synchronous in preparation for the task's migration to another processor (making the task easy to migrate), and then be switched back to asynchronous operation upon its successful migration to the other processor. Again, this is because, in making the task synchronous, only one thread is allowed to run at any one time.

As will be appreciated by one of skill in the art, given the foregoing, a number of benefits are provided by optional thread pre-emption. Code that is executed synchronously can be executed more quickly, as a result of having fewer instructions. Because the use of synchronous threads isolates threads from one another, and so avoids timing-related errors and the use of protective instructions, the programmer will typically be able to write the program and have the program running correctly in less time. Synchronous tasks are isolated from one another as a result of their being non-pre-emptible, on an intra-task basis, and as a result of such threads being in different tasks, on an inter-task basis. In an operating system such as that presented herein, the maintenance of such separation is provided by using message passing as only method of inter-task interaction.

A task's threads can also be made pre-emptible on a case-by-case basis, so that if a task will not benefit appreciably from being run on multiple processors, the task's threads can be made non-pre-emptible. In doing so, and so as a result of obviating the need for atomic instructions, the programmer's task of coding the task is simplified and its efficiency increased. Moreover, timing-related errors are also avoided thereby, as noted. Because each thread must stop at a well-defined point (e.g., a directive call), and so context switching occurs at well-defined points, no synchronization internal to task is required—support for synchronous threads does away with the need for management overhead of asynchronous tasks (data structures that support synchronization between threads). For example, there is no need for synchronization locks when synchronous threads are supported. As noted, of course, pre-emption can still occur between tasks (inter-task pre-emption), just not internal to a task (intra-task pre-emption).

Of course, if thread pre-emption is optional, the programmer is given the ability to start by writing and running a task synchronously, then migrate to running the task asynchronously, in order to identify timing-related errors. Such an approach also offers flexibility as a result of its simple programmatic constructs.

As noted, in a multiprocessor environment (e.g., SMP environment), tasks/threads need not be bound to a given processor. If a task will not see significant performance gains from running on more than one processor at a time, non-pre-emptibility can be the default, providing the aforementioned advantages and benefits. However, if a task will see significant performance gains from running on more than one processor at a time, non-pre-emptibility can be used to simplify the tasks' debugging and operation, as noted. For example, a programmer can dynamically set the task count (the number of running threads) to zero, and so quiesce the executing tasks (which will stop running at some point). In some period of time, the entire task will quiesce, with the entire task in its image, and nothing outstanding, running.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

What is claimed is:

1. A method of executing a thread comprising:
preventing a first thread from pre-empting said thread, wherein
said first thread and said thread are ones of a plurality of threads,
a task comprises said threads, and
said first thread is prevented from preempting said thread until said thread makes a system call to an operating system.

2. The method of claim 1, further comprising:
indicating that said thread is non-pre-emptible.

3. The method of claim 2, further comprising:
indicating that said thread is pre-emptible.

4. The method of claim 3, further comprising:
if said thread is pre-emptible, allowing said first thread to pre-empt said thread.

5. The method of claim 1, wherein
said operating system prevents said first thread from pre-empting said thread.

6. The method of claim 5, wherein said preventing further comprises:
preventing a context switch from said thread to said first thread.

7. The method of claim 1, wherein
said operating system is configured to operate a symmetric multi-processing computer system.

8. An operating system in which a thread is executed comprising:
a task comprising a plurality of threads, wherein
said operating system is configured to cause execution of said thread,
said thread is one of said threads, and
said operating system can be configured to select whether said thread is pre-emptible or non-pre-emptible.

9. The operating system of claim 8, wherein
said operating system is further configured to prevent a first thread from pre-empting said thread, if said thread is non-pre-emptible, and
said first thread is one of said threads.

10. The operating system of claim 9, wherein said said operating system is further configured to prevent said first thread from pre-empting said thread by virtue of being configured to prevent a context switch from said thread to said first thread.

11. The operating system of claim 10, wherein said said operating system is further configured to prevent said context switch by virtue of being configured to prevent said first thread from pre-empting said thread until said thread makes a system call to said operating system.

12. The operating system of claim 8, wherein
said operating system is further configured to allow a first thread from pre-empting said thread, if said thread is pre-emptible, and
said first thread is one of said threads.

13. A method of executing a thread comprising:
indicating that said thread is one of a pre-emptible thread and a non-pre-emptible thread.

14. The method of claim 13, further comprising:
if said thread is indicated to be said non-pre-emptible thread, preventing a first thread from pre-empting said thread, wherein
said first thread and said thread are ones of a plurality of threads, a task comprises said threads, and
said first thread is prevented from preempting said thread until said thread makes a system call to an operating system.

15. The method of claim 14, wherein
said operating system prevents said first thread from pre-empting said thread.

16. The method of claim 15, wherein said preventing further comprises:
preventing a context switch from said thread to said first thread.

17. The method of claim 14, wherein
said operating system is configured to operate a symmetric multi-processing computer system.

18. The method of claim 13, further comprising:
if said thread is indicated to be pre-emptible, allowing a first thread to pre-empt said thread, wherein
said first thread and said thread are ones of a plurality of threads, and
a task comprises said threads.

19. The method of claim 18, wherein
said task is supported by an operating system, and
said operating system is configured to operate a symmetric multi-processing computer system.

20. A computer system comprising:
a processor;
computer readable medium coupled to said processor; and
computer code, encoded in said computer readable medium, for executing a thread and configured to cause said processor to:
indicate that said thread is one of a pre-emptible thread and a non-pre-emptible thread.

21. The computer system of claim 20, wherein said computer code is further configured to cause said processor to:
prevent a first thread from pre-empting said thread, if said thread is indicated to be said non-pre-emptible thread, wherein
said first thread and said thread are ones of a plurality of threads,
a task comprises said threads, and
said first thread is prevented from pre-empting said thread until said thread makes a system call to an operating system.

22. The computer system of claim 21, wherein
said operating system is configured to prevent said first thread from pre-empting said thread.

23. The computer system of claim 22, wherein said computer code configured to cause said processor to prevent said first thread from pre-empting said thread is further configured to cause said processor to:
prevent a context switch from said thread to said first thread.

24. The computer system of claim 21, wherein
said computer system is a symmetric multi-processing computer system.

25. The computer system of claim 20, wherein said computer code is further configured to cause said processor to:
allow a first thread to pre-empt said thread, if said thread is indicated to be said pre-emptible thread, wherein
said first thread and said thread are ones of a plurality of threads, and
a task comprises said threads.

26. The computer system of claim 25, wherein
said task is supported by an operating system, and
said computer system is a symmetric multi-processing computer system.

27. A computer program product comprising:
a first set of instructions, executable on a computer system, configured to indicate that said thread is one of a pre-emptible thread and a non-pre-emptible thread; and
computer readable media, wherein said computer program product is encoded in said computer readable media.

28. The computer program product of claim 27, wherein said second set of instructions comprises:
a second set of instructions, executable on said computer system, configured to prevent a first thread from pre-empting said thread, if said thread is indicated to be said non-pre-emptible thread, wherein
said first thread and said thread are ones of a plurality of threads,
a task comprises said threads, and
said first thread is prevented from pre-empting said thread until said thread makes a system call to an operating system.

29. The computer program product of claim 28, wherein
said operating system is configured to prevent said first thread from pre-empting said thread.

30. The computer program product of claim 27, wherein said second set of instructions comprises:
a second set of instructions, executable on said computer system, configured to allow a first thread to pre-empt said thread, if said thread is indicated to be said pre-emptible thread, wherein
said first thread and said thread are ones of a plurality of threads, and
a task comprises said threads.

31. An apparatus for executing a thread comprising:
means for indicating that said thread is one of a pre-emptible thread and a non-pre-emptible thread.

32. The apparatus of claim 31, further comprising:
means for preventing a first thread from pre-empting said thread, if said thread is indicated to be said non-pre-emptible thread, wherein
said first thread and said thread are ones of a plurality of threads,
a task comprises said threads, and
said first thread is prevented from pre-empting said thread until said thread makes a system call to an operating system.

33. The apparatus of claim 32, wherein
said operating system prevents said first thread from pre-empting said thread.

34. The apparatus of claim 33, wherein said means for preventing further comprises:
means for preventing a context switch from said thread to said first thread.

35. The apparatus of claim 32, wherein
said operating system is configured to operate a symmetric multi-processing computer system.

36. The apparatus of claim 31, further comprising:
means for allowing a first thread to pre-empt said thread, if said thread is indicated to be pre-emptible, wherein
said first thread and said thread are ones of a plurality of threads, and
a task comprises said threads.

37. The apparatus of claim 36, wherein
said task is supported by an operating system, and
said operating system is configured to operate a symmetric multi-processing computer system.
